(19) United States
(12) Patent Application Publication
(10) Pub. No.: US 2006/0115063 A1
(43) Pub. Date: Jun. 1, 2006

(54) Transmitting data via Caller-ID information

(76) Inventor: Tony Givargis, Irvine, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/001,981

(22) Filed: Dec. 1, 2004

(51) Int. Cl. H04M 1/56; H04M 11/00

(52) U.S. Cl. 379/142.01; 455/415

(57) ABSTRACT

The present invention provides a method for transmitting data via Caller-ID information. An initiating device initiates phone calls, with their associated Caller-ID information, over a phone line to a callee. The data is identified by the Caller-ID information. The Caller-ID information that identifies the data may be a phone number of the calling party, a date and/or time the phone call was made, and so forth. A receiving device, at the callee location, receives the phone calls, with their associated Caller-ID information and additionally receives personal phone calls, with their associated Caller-ID information. A microprocessor, at the callee location, compares all Caller-ID information received by the receiving device to preinstalled Caller-ID information and if the received Caller-ID information matches any preinstalled Caller-ID information, then the data, identified by the Caller-ID information, is extracted.

### FIELD OF THE INVENTION

The field of the invention is transmitting data via Caller-ID information.

### BACKGROUND OF THE INVENTION

Data has been transmitted over phone lines for many years. The data is either directly received by an individual or by a device that stores the data for later retrieval by the individual. However, in both of the above cases a call has been completed to the individual's residence, office or other location (callee), where the receiving device is located. Frequently, several seconds have elapsed before the call is completed and the data has been transmitted to the callee. This will limit the number of callees, who will be able to receive the data during a certain set period of time from a given initiating phone call source.

Today automatic number identification (ANI) and Caller-ID services are provided to telephone users and are discussed in U.S. Pat. No. 5,276,731 issued January 1994, to Arbel, et al., U.S. Pat. No. 5,796,815 issued August 1998, to Guercio et al. and U.S. Pat. No. 5,883,942 issued March 1999, to Lim, et al. These services allow the callee to identify the calling party before accepting the call and before the call is completed. The phone number and/or the name of the calling party comprise the primary information that is provided to the callee. However, with some telephone services the date and time of the call may also be provided to the callee. All of this Caller-ID information is provided to the callee between the first and second ring or generally during the first six seconds after the call has been received by a receiving device at the callee's residence or business. If data could be transmitted during this six second pre-answering time frame, it would substantially increase the number of callees that could receive such data during a set period of time.

What is needed is devices and methods to transmit data to a callee, during the approximately six second pre-answering time frame, when the Caller-ID information is displayed to the callee and prior to the call being completed to the callee.

### SUMMARY OF THE INVENTION

The present invention provides methods for transmitting data, generally comprising the steps of: initiating a phone call to a callee in a manner that provides the data to the callee in a pre-answering time frame during which time Caller-ID information can be sent; receiving the call at the callee's location; extracting the data from the Caller-ID information; and using the extracted data in an operation.

Preferably the initiating device is a telephone. Alternatively, the initiating device may be a computer or any other device that can initiate a phone call. The phone call may be transmitted along a hard-wired phone line, by wireless means or by any other appropriate means.

In a preferred embodiment of the present invention, the data will be identified by, and extracted from, the Caller-ID information. Alternatively, the data may be appended to the Caller-ID information.

Preferably, the Caller-ID information that identifies the data will consist of a phone number. However, it can be appreciated that the Caller-ID information that identifies the data may consist of the date and time the phone call was made or any other Caller-ID information that is at present or will in the future be sent and displayed to the callee.

In some cases, there will be personal phone calls transmitted to the callee that include the Caller-ID information but omit the data.

In a preferred embodiment of the present invention, a microprocessor disposed in a computer will be utilized to extract the data from the Caller-ID information. Alternatively, a microprocessor disposed in an irrigation controller or a microprocessor disposed in any other device that is used in an operation at the callee's location, may be utilized to extract the data from the Caller-ID information.

It is contemplated that the data can be used in any appropriate operation, including an irrigation operation, a manufacturing operation or any other operation, if the operation uses data that can be identified by Caller-ID information.

If the operation involves an irrigation operation, then the data may comprise ETo data or the weather factors from which the ETo data is derived. Alternatively, the data may be irrigation control data or any other data used in an irrigation operation.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic exemplifying a method for transmitting data via Caller-ID information, according to an aspect of the present invention.

FIG. 2 is a schematic exemplifying a method for transmitting data via Caller-ID information, when the receiving device is an irrigation controller.

FIG. 3 is a flow chart of steps involved in one aspect of a preferred embodiment of the present invention.

### DETAILED DESCRIPTION

The present invention, as described herein, could be used in many different operations so long as the operation uses data that can be identified by Caller-ID information. The present invention could be used in an irrigation operation, where the scheduling of an irrigation application may involve the use of data that is transmitted from a distal source to the location of the irrigation controller. This data may include reference evapotranspiration (ETo) data, weather data from which the ETo data is derived, irrigation control data, peak water use data, electric load data, and so forth. The present invention could be used in a manufacturing operation, where raw materials have to be ordered from distal sources. Additionally, the present invention could be used in retail operations, where goods are purchased from distal sources. There are many other operations, where the present invention could be advantageously used, if data from distal sources is required and the data can be identified by Caller-ID information. It is contemplated that unmodified Caller-ID information, provided by telephone service providers, will be utilized in the present invention.

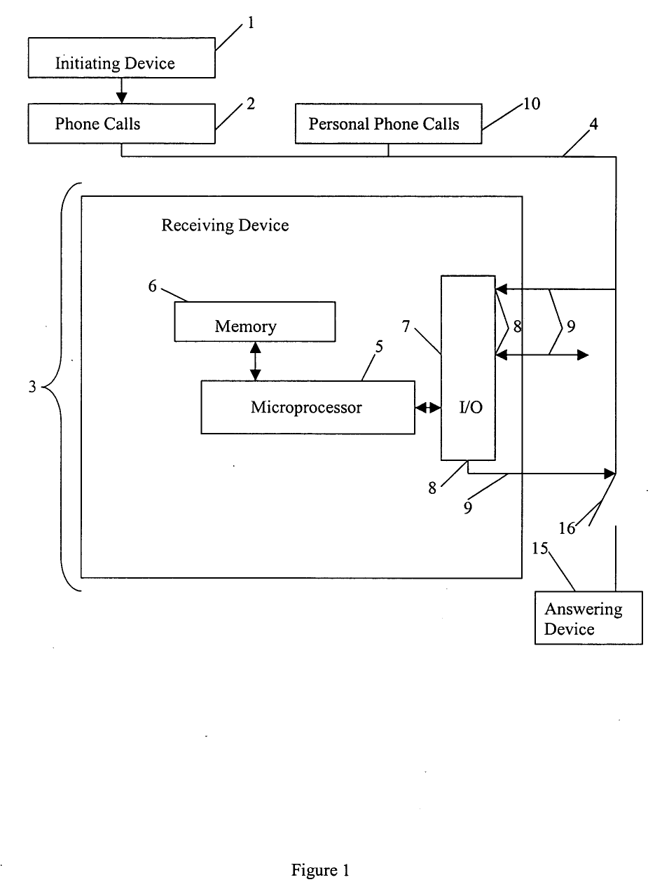

FIG. 1 is a schematic exemplifying a method for transmitting data according to an aspect of the present invention. The initiating device 1 transmits phone calls 2, with their associated Caller-ID information, to a receiving device 3 over wired or wireless phone lines 4. Preferably, the initiating device 1 is a telephone. Alternatively, the initiating device 1 may be a computer or other device that can initiate phone calls.

The receiving device 3 may be a computer or any other device that is set up and programmed to receive phone calls.

In a preferred embodiment of the present invention, the receiving device 3 will have disposed in it a microprocessor 5, a memory 6, input/output circuitry 7, communication ports 8, a serial, parallel or other communication connections 9 coupling the receiving device to other devices, such as telephone lines 4, computers, and so forth. It can be appreciated that although the above items are preferably disposed in the receiving device 3, they may be disposed in other devices or be stand alone devices and then have connections to the receiving device 3.

Receiving device 3 can receive calls initiated by the initiating device 1 as well as calls initiated by other devices. The receiving device 3 can receive personal phone calls 10, with their associated Caller-ID information over the phone lines 4. The personal phone calls 10, as used herein, refer not only to personal communications but also to fax transmissions or any other calls that are made to the same phone number, where the initiating device 1 makes its phone calls 2 to.

In a preferred embodiment of the present invention, if the call is a personal phone call 10, then the microprocessor 5 will be programmed to relay the personal phone call 10 to the answering device 15 by the closing of a relay switch 16. It can be appreciated that means other than a simple relay switch 16, could be used to allow the personal phone calls 10 to be relayed to the answering device 15.

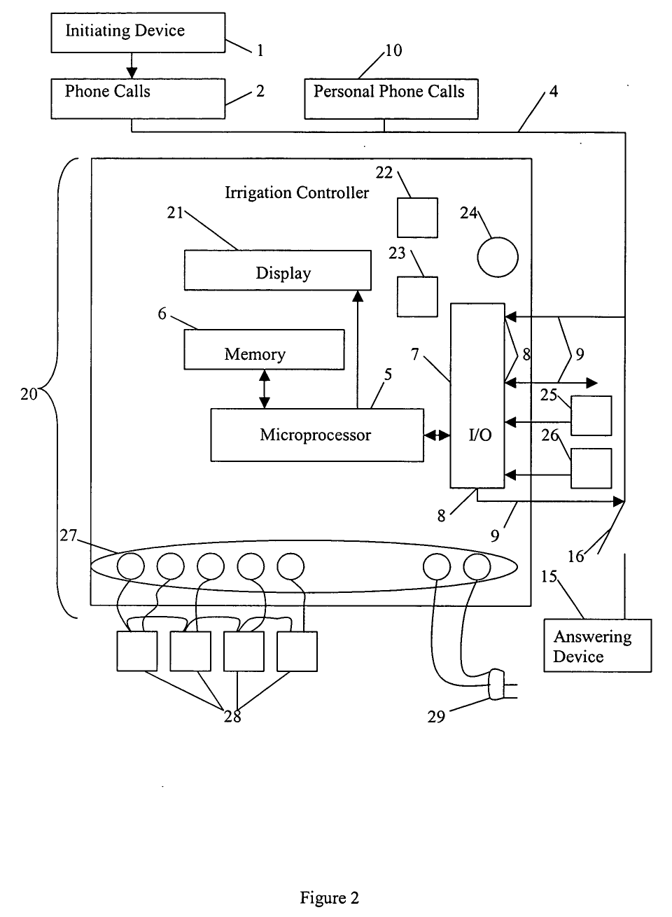

FIG. 2 is a schematic exemplifying a method for transmitting data via Caller-ID information, when the receiving device is an irrigation controller 20. The irrigation controller 20 generally includes a microprocessor 5, an on-board memory 6, a display screen 21, some manual input devices 22 through 24 (buttons and/or knobs), an input/output (I/O) circuitry 7, communications ports 8, a serial, parallel or other communications connections 9 coupling the irrigation controller to other devices, such as telephone lines, personnel computers, etc., electrical connectors 27, which are connected to a plurality of irrigation stations 28 and a power supply 29 and may include connections to sensors 25 and 26, such as rain sensors, flow sensors, pressure sensors, temperature sensors, etc. Each of these components by itself is well known in the electronic industry, with the exception of the programming of the microprocessor in accordance with the functionality set forth herein. There are hundreds of suitable chips that can be used for this purpose. At present, experimental versions have been made using a generic Intel 80C54 chip, and it is contemplated that such a chip would be satisfactory for production models.

Preferably, the irrigation controller 20 has one or more common communication internal bus(es). The bus can use a common or custom protocol to communicate between devices. There are several suitable communication protocols, which can be used for this purpose. At present, experimental versions have been made using an I.sup.2c serial data communication and it is contemplated that this communication method would be satisfactory for production models. This bus is used for internal data transfer to and from the EEPROM memory and is used for communication with peripheral devices and measurement equipment including but not limited to rain sensors, flow sensors, pressure sensors and temperature sensors.

In a preferred embodiment of the present invention, the initiating device 1 will be located at a water district facility and will initiate phone calls 2, with their associated Caller-ID information that identifies specific ETo data, to the irrigation controller 20. The ETo data will be used in the scheduling of an irrigation application. Alternatively, the initiating device 1 may be located at a weather station site, where the environmental data, used in the derivation of the ETo value, is collected. If the initiating device 1 is located at a water district facility, the water district will first obtain the ETo data from a weather station and then send the ETo data to the irrigation controller 20. The water district will use Caller-ID information that identifies an ETo value for a specific day at the weather station location. The water district will transmit the phone call 2, with it's associated Caller-ID information over the phone line 4 to the irrigation controller 20.

The irrigation controller 20, in addition to receiving phone calls from the initiating device 1, will receive personal phone calls 10, with their associated Caller-ID information over the phone line 4. Preferably, if the call is a personal phone call 10, then the microprocessor 5 will be programmed to relay the personal phone call 10 to the answering device 15 by the closing of the relay switch 16.

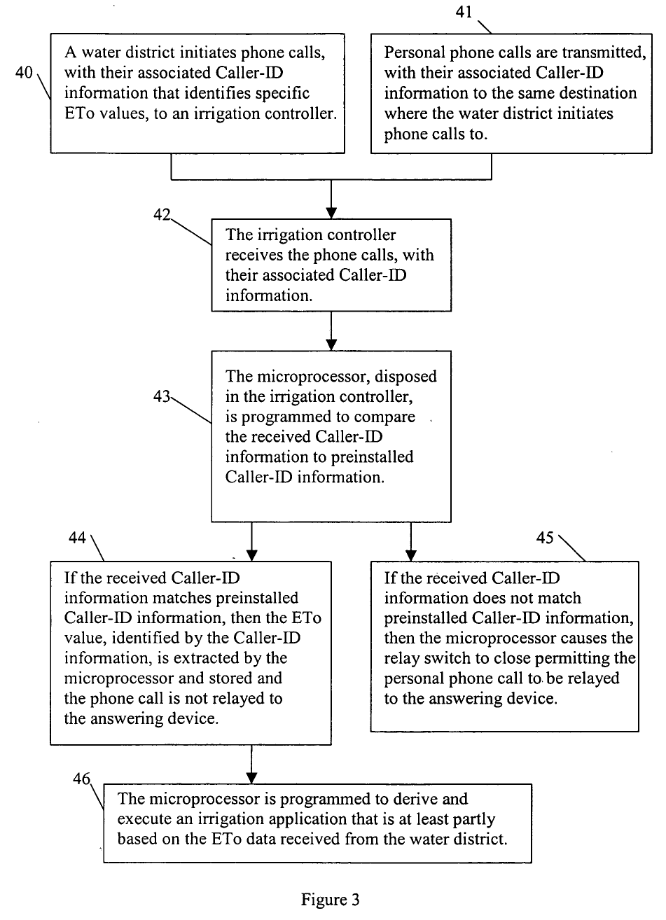

FIG. 3 is a flow chart of steps involved in the transmitting of data that is used in an irrigation operation according to an aspect of the present invention. In the initial step, a water district initiates phone calls, with their associated Caller-ID information that identifies specific ETo values, to an irrigation controller 40. The ETo values are specific for the irrigation site, where the irrigation application is to be applied. The irrigation controller derives and executes the irrigation application that is at least partly based on the ETo data that is received from the water district. It is anticipated that the phone calls will be initiated by a telephone system. However, they could be initiated by a computer, cellular phone or any other suitable means for initiating phone calls.

Preferably, a Caller-ID telephone number will be used, as the identifier of the ETo value. It could be a single telephone number, a portion of a telephone number, or a combination of telephone numbers that identifies the ETo value. For example, with a combination of telephone numbers, the first number could identify the most significant digit of the ETo value and the second telephone number could identify the least significant digit of the ETo value. It can be appreciated, that Caller-ID information, other than telephone numbers, can be used as identifiers, such as date and time the phone call was made. Additionally it could be a combination of Caller-ID information that could be used to identify specific ETo values that are obtained from specific weather stations. For example, a telephone number could be used to identify the weather station the ETo data originated from and the time of day the phone call was made could be used to identify a specific ETo value. It can be appreciated that the Caller-ID information, used to identify data, can include any Caller-ID information provided by telephone service providers. It is contemplated that unmodified Caller-ID information and processes provided by telephone service providers will be used to transmit the data.

In a preferred embodiment of the present invention, the water district will have a plurality of phone lines, with each phone line identifying a specific ETo value. For example, if the region, where the weather station is located, has a range of ETo values from 0 to 0.40 inches then there could be 40 phone lines, with each having a phone number to identify each 0.01 inch ETo value increment from 0 to 0.40 inches. However, this could be very costly and therefore, it is anticipated that only some of the ETo values will be identified by phone numbers (See Table 1 below).

TABLE 1

| Phone Number | ETo (Inches) |
|---|---|
| 909-787-0123 | 0.00 |
| 909-787-1234 | 0.05 |
| 909-787-2345 | 0.10 |
| 909-787-3456 | 0.15 |
| 909-787-4567 | 0.20 |
| 909-787-5678 | 0.25 |
| 909-787-6789 | 0.30 |
| 909-787-7890 | 0.35 |
| 909-787-8901 | 0.40 |

In this example, there are nine phone numbers that are used to identify nine ETo values. On any given day, the call from the water district to the irrigation controller that executes an irrigation application in the same region as the weather station will be made from the phone line that identifies the ETo value that is the closest to the actual ETo value for a given day at that weather station. For example, assume that on day 1 the actual ETo value is 0.11 inches. The closest identified ETo value, to 0.11 inches, is 0.10 inches. Therefore, the phone call from the water district to the irrigation controller will be made on the phone line, with the phone number 909-787-2345. However, the actual ETo value was 0.11 inches so there is an error of 0.01 inches. On the following day, before the water district calls the irrigation controller, an adjustment will be made to the ETo value that is obtained from the weather station. The error in the transmission of the ETo value will be either added to or subtracted from the following days actual ETo value that is obtained from the weather station. Assume that the following day, the actual ETo value is 0.08 inches. Therefore, 0.01 inches will be added to the 0.08 inches for an ETo value to be transmitted of 0.09 inches. Since 0.10 inches is the closest ETo value to 0.09 inches the call from the water district for day 2 will again be made from the phone line, with the phone number 909-787-2345. The same scheme, as described above, will be used on each subsequent day for determining, which phone line will be used to initiate the call from the water district to the irrigation controller (See Table 2 below).

TABLE 2

| | Actual | Adjusted | ETo Value | | Phone Number |
|---|---|---|---|---|---|
| Day | ETo (In.) | ETo Value | Sent | Error | Call Made From |
| 1 | .11 | .11 | .10 | .01 | 909-787-2345 |
| 2 | .08 | .09 | .10 | −.01 | 909-787-2345 |
| 3 | .24 | .23 | .25 | −.02 | 909-787-5678 |
| 4 | .33 | .31 | .30 | .01 | 909-787-6789 |
| 5 | .15 | .16 | .15 | .01 | 909-787-3456 |
| 6 | .12 | .13 | .15 | −.02 | 909-787-3456 |

The previous paragraphs disclose using Caller-ID information as identifiers of data that is transmitted, as part of the Caller-ID information, from the calling party to the callee. It should be understood that the data extracted from the Caller-ID information can be used directly in an operation or can be further interpreted before being used in an operation. In some embodiments, data will not be extracted directly from the Caller-ID information but will be appended to the Caller-ID information. Additionally, the previous paragraphs disclose using Caller-ID information to transmit ETo data from the water district to the irrigation controller. It is contemplated that the Caller-ID information will be used to transmit data, other than ETo data, from the water district or other entity to the irrigation controller. This could include weather factors used in the deriving of the ETo data, irrigation control data and other irrigation operation data. For example, if during peak water use periods, there was excessive water being applied, in the water district's supply area, the data, identified by the Caller-ID information, may include control data that would result in the turning off of some of the irrigation controllers so that water use, in the water districts supply area, does not exceed a maximum amount.

In step 41, personal phone calls are transmitted, with their associated Caller-ID information, to the same destination, where the water district transmits phone calls to. In a preferred embodiment of the present invention, a dedicated phone line is not required for the water district to transmit calls to the irrigation controller. Calls from the water district to the irrigation controller can be made over existing phone lines that are used for other purposes at the residential, commercial, agricultural or other site where the irrigation controller is located. Personal phone calls, as referred to herein, include personal calls, business calls, faxes and other calls that are transmitted to the site, where the irrigation controller is located.

The irrigation controller receives the phone calls, with their associated Caller-ID information 42. This includes the phone call from the water district, as well as the personal phone calls that are transmitted to the same destination phone number as the water district's call was made to.

In a preferred embodiment of the present invention, the microprocessor, disposed in the irrigation controller, is programmed to compare the received Caller-ID information to preinstalled Caller-ID information 43. The preinstalled Caller-ID information that identifies specific ETo values is similar to the data in Table 1, which involved Caller-ID information that the water district used to identify specific ETo values.

If the received Caller-ID information matches preinstalled Caller-ID information, then the ETo value, identified by the Caller-ID information, is extracted by the microprocessor and stored and the phone call is not relayed to the answering device 44. Preferably, the ETo value is stored in memory to be later used by the microprocessor. However, it can be appreciated that the microprocessor may immediately use the ETo data, in a programmed irrigation operation, and not have to store the data for later use. It is contemplated that the microprocessor will be programmed to derive and execute an irrigation application that is at least partly based on the ETo data received from the water district 46.

In a preferred embodiment of the present invention, if the received Caller-ID information does not match preinstalled Caller-ID information, then the microprocessor causes the relay switch to close permitting the personal phone call to be relayed to the answering device 45. If the personal phone call is a call from a calling party to the callee, a telephone will ring notifying the callee that they have a phone call. If the personal call is a fax from the calling party to the callee, a fax machine, at the callee's location, will receive and download the fax.

The entire sequence of events, listed in FIG. 3, occur during a silent period between when the first and second ring tones would have occurred. In a preferred embodiment of the present invention, no phone calls that are used to transmit the ETo data from the water district to the irrigation controller are completed calls.

Thus, specific embodiments and applications of methods and apparatus of the present invention have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A method for transmitting data, comprising:
initiating a phone call to a callee in a manner that provides the data to the callee in a pre-answering time frame during which time Caller-ID information can be sent;
receiving the call at the callee's location;
extracting the data from the Caller-ID information; and
using the extracted data in an operation.

2. The method of claim 1, further comprising transmitting the phone call along a hard-wired phone line.

3. The method of claim 1, further comprising transmitting the phone call wirelessly.

4. The method of claim 1, wherein the initiating device is a telephone.

5. The method of claim 1, wherein the initiating device is a computer.

6. The method of claim 1, further comprising having the data be identified by the Caller-ID information.

7. The method of claim 1, further comprising having the data appended to the Caller-ID information.

8. The method of claim 6, wherein the Caller-ID information comprises a phone number.

9. The method of claim 6, wherein the Caller-ID information comprises the date and time the phone call was made.

10. The method of claim 1, further comprising transmitting other personal phone calls to the callee that include the Caller-ID information but omit the data.

11. The method of claim 1, further comprising utilizing a microprocessor disposed in a computer to extract the data.

12. The method of claim 1, further comprising utilizing a microprocessor disposed in an irrigation controller to extract the data.

13. The method of claim 1, wherein the data used in an operation comprises data used in an irrigation operation.

14. The method of claim 1, wherein the data used in an operation comprises data used in a manufacturing operation.

15. The method of claim 13, wherein the data comprises reference evapotranspiration (ETo) data.

16. The method of claim 13, wherein the data comprises irrigation control data.
